(19) United States
(12) Patent Application Publication
(10) Pub. No.: US 2020/0311764 A1
(43) Pub. Date: Oct. 1, 2020

(54) EXPERIMENT STRATEGY FOR MEMBER-BASED RAMPING

(71) Applicant: Microsoft Technology Licensing, LLC, Redmond, WA (US)

(72) Inventors: Wen Pu, Santa Clara, CA (US); Keqing Liang, Sunnyvale, CA (US); Jianqiang Shen, San Mateo, CA (US); Sumedha K. Swamy, San Jose, CA (US); Prashanth Govindarajan, Cupertino, CA (US)

(73) Assignee: Microsoft Technology Licensing, LLC, Redmond, WA (US)

(21) Appl. No.: 16/369,283

(22) Filed: Mar. 29, 2019

(51) Int. Cl. G06Q 30/02

(52) U.S. Cl. CPC G06Q 30/0244; G06Q 20/28; G06Q 30/0243

(57) ABSTRACT

The disclosed embodiments provide a system for performing an experiment strategy for member-based ramping. During operation, the system divides members of an online system into a control group and a treatment group. Next, the system configures delivery of content to the control group over a first set of channels that charge for actions related to the content and delivery of the content to the treatment group over a second set of channels that charge for the actions related to the content, wherein the second set of channels is smaller than the first set of channels. The system then performs a first experiment that selects an adjustment factor for content delivered over the second set of channels to the treatment group to achieve revenue neutrality and/or engagement neutrality between the treatment and control groups.

### RELATED APPLICATIONS

The subject matter of this application is related to the subject matter in a co-pending non-provisional application entitled “Dynamic Optimization for Jobs,” having Ser. No. 16/232,862, and filing date 26 Dec. 2018.

### BACKGROUND

### Field

The disclosed embodiments relate to delivery of content in online systems. More specifically, the disclosed embodiments relate to an experiment strategy for member-based ramping during delivery of content in online systems.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for performing an experiment strategy in accordance with the disclosed embodiments.

FIG. 3 shows a flowchart illustrating a process of performing an experiment strategy in accordance with the disclosed embodiments.

FIG. 4 shows a computer system in accordance with the disclosed embodiments.

In the figures, like reference numerals refer to the same figure elements.

5

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments a method, apparatus, and system for delivering content in online systems. For example, the content may include jobs that are posted within an online system such as an online network and/or online marketplace. Each job is associated with a daily and/or other time-based budget that is spent as candidates view, click on, apply to, and/or perform other actions related to the job. As a result, bid prices for each job may be dynamically adjusted so that the job's budget can be consumed over the course of the day instead of running out too early and/or failing to be used up by the end of the day. Bid prices for jobs may also, or instead, be dynamically adjusted to improve application rates, applicant quality, revenue and/or other performance factors related to the jobs.

More specifically, the disclosed embodiments include an experiment strategy that performs member-based ramping to switch from charging for activity related to delivering content across a large number of channels to charging for activity related to delivering content over a smaller number of channels. For example, the experiment strategy may control switching from charging for views and/or clicks of jobs delivered across all channels in an online network to charging only for views and/or clicks of jobs that are delivered over channels that optimize for engagement, revenue, and/or other factors that improve the value of the delivered jobs to posters of the jobs. By transitioning to charging for jobs only through such “optimized” channels, the disclosed embodiments allow the amount the posters pay for the jobs to directly impact the value received by the posters from the jobs.

First, the experiment strategy involves determining an adjustment factor to prices for content delivered over a smaller number of channels to the treatment group that achieve revenue neutrality and/or near engagement neutrality with the control group. For example, the adjustment factor may scale prices of content delivered to the treatment group based on the percentage of members to which exposure to the treatment group is ramped and/or the predicted engagement of members in the treatment and control groups with the content. A first series of experiments may be conducted to select a value of the adjustment factor that best achieves revenue and/or engagement neutrality between the treatment and control groups.

Second, the experiment strategy involves updating dynamic pricing components of content delivered to the treatment group that achieve revenue neutrality and engagement neutrality between the treatment and control groups. For example, a second series of experiments may update a function for calculating a dynamic adjustment based on an actual spending for a content item at a current time and an expected spending for the content item at the current time, set a higher upper bound for the dynamic adjustment, and/or adjust a balancing factor that balances revenue with engagement in the delivered content so that dynamic prices calculated for the content can reflect the adjustment factor determined in the first series of experiments. The second series of experiments may also verify that the combination of the adjustment factor identified in the first series of experiments and the updated dynamic pricing components can be used to achieve revenue neutrality and engagement neutrality between the treatment and control groups.

The experimental strategy additionally involves performing one or more additional experiments that alternate between assigning all members of the online system to the treatment group over a period and assigning all members of the online system to the control group over a subsequent period. For example, the experimental strategy may run an experiment over a two-week period and switch between assigning all members to the treatment group and the control group on alternating days. The experiment may aggregate metrics collected from the treatment and control groups over the two-week period, so that each group has a full week's worth of data that can be compared with another full week's worth of data for the other group. As a result, the experiment may be used to verify that the treatment group is substantially revenue and engagement neutral with respect to the control group across the entire marketplace used to deliver content to members of the online system.

By discontinuing charging for content delivered over “organic” channels that deliver jobs without performing optimizations related to the jobs and charging only for content delivered over channels that optimize for revenue, engagement, and/or performance, the disclosed embodiments allow the value received by posters of the delivered content to be affected by budgets for the content. At the same time, the use of experiments to update prices and/or parameters for delivering content over different numbers of channels may ensure a stable and/or controlled transition from charging for content delivery over a larger number of channels to charging for content delivery over a smaller number of channels. Moreover, member-level ramping performed by the experiment allows revenue and engagement neutrality to be achieved without introducing auction-level bias between content in the treatment and control groups of the experiment.

In contrast, conventional techniques may continue charging for delivery of content over a predetermined set of channels, which can include both “organic” channels that do not optimize for revenue, engagement, and/or performance, as well as “optimized” channels that deliver content to improve revenue, engagement and/or performance. As a result, posters that pay for delivery of the content may be unable to effect changes in clicks, conversions, applications and/or other outcomes related to the content through changes to the budgets for the content.

The conventional techniques may also, or instead, lack the ability to reduce the number of channels over which paid content is delivered in a controlled fashion. For example, a conventional content delivery system may fail to adjust prices and/or other parameters related to pricing for delivered content after a reduction in the number of channels over which the delivered content is charged. When pricing of content is not adjusted to account for a reduction in the volume of paid content delivered to members, the overall revenue received from the paid content may drop, and engagement with the content may fluctuate. Consequently, the disclosed embodiments may provide improvements in computer systems, applications, user experiences, tools, and/or technologies related to delivering online content and/or carrying out activities within online systems.

### Experiment Strategy for Member-Based Ramping

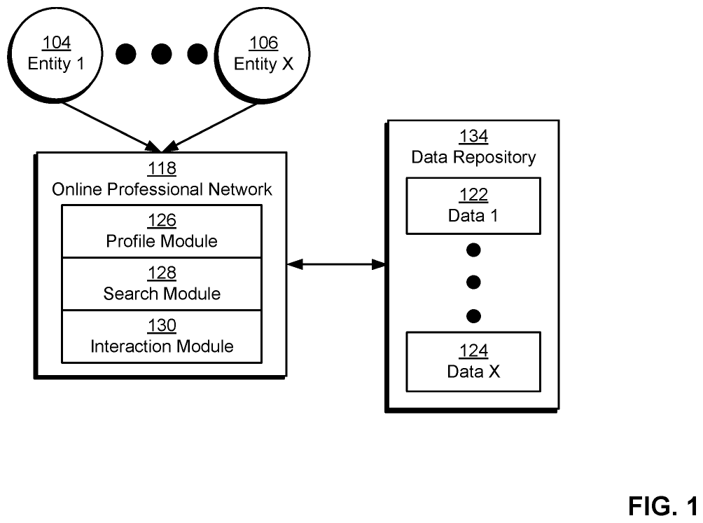

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that delivers, to the entities, the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, applications, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

In one or more embodiments, data repository 134 stores data that represents standardized, organized, and/or classified attributes for the users or entities. For example, skills in data repository 134 may be organized into a hierarchical taxonomy. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve other data that is represented by the time periods (e.g., starting a job in a given month or year, graduating from university within a five-year span, job listings posted within a two-week period, etc.).

More specifically, data in data repository 134 and one or more machine learning models are used to produce rankings related to candidates for jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strengths of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may output a ranking of jobs as search results to a candidate after the candidate specifies one or more attributes of the jobs in a job search. In a fifth example, the component(s) may recommend jobs to a candidate based on the predicted relevance or attractiveness of the jobs to the candidate and/or the candidate's likelihood of applying to the jobs.

Jobs, advertisements, and/or other types of content displayed or delivered within online network 118 may also be associated with time-based limitations or constraints. For example, posters of jobs may pay per click, application, and/or other action taken with respect to the jobs by members of online network 118. The posters may set daily budgets for the jobs, from which costs are deducted as the members take the corresponding actions with the jobs. If a job's budget is fully consumed before the end of the day, the job may continue to be delivered to members (e.g., in search results and/or recommendations) until the end of the day without further charging the job's poster. Moreover, jobs with depleted budgets may occupy space in rankings that are shown to the members, which may prevent online network 118 from surfacing other jobs to the members and/or utilizing the budgets for the other jobs.

In one or more embodiments, online network 118 manages daily budgets and/or other constraints or priorities associated with jobs and/or other content in online network 118 by performing dynamic optimization of bid prices for the jobs. For example, online network 118 may calculate a new cost per click (CPC) for each job every time the job is outputted in search results and/or a ranking to one or more candidates. The CPC may be calculated to reflect anticipated interactions with the job, improve utilization of the job's budgets, increase the jobs' performance with respect to applications or applicants, and/or accommodate other optimization objectives. As a result, the bid prices may allow for a more even exposure of members to the jobs and/or may better reflect the “values” of the jobs within online network 118 and/or recent interactions or feedback related to the jobs. Dynamic optimization of job bids is described in further detail in a co-pending non-provisional application entitled “Dynamic Optimization for Jobs,” having Ser. No. 16/232,862 and filing date 26 Dec. 2018, which is incorporated herein by reference.

In one or more embodiments, online network 118 further includes functionality to carry out an experiment strategy that allows jobs and/or other content to transition from charging for activity related to the content across a large number of channels to charging for activity related to the content over a smaller number of channels. For example, the experiment strategy may be used to test and/or control switching from charging for views and/or clicks of jobs that are delivered across all channels in online network 118 to charging only for views and/or clicks of jobs that are delivered over channels that optimize for engagement, revenue, and/or other factors that improve the value of the jobs to posters of the jobs.

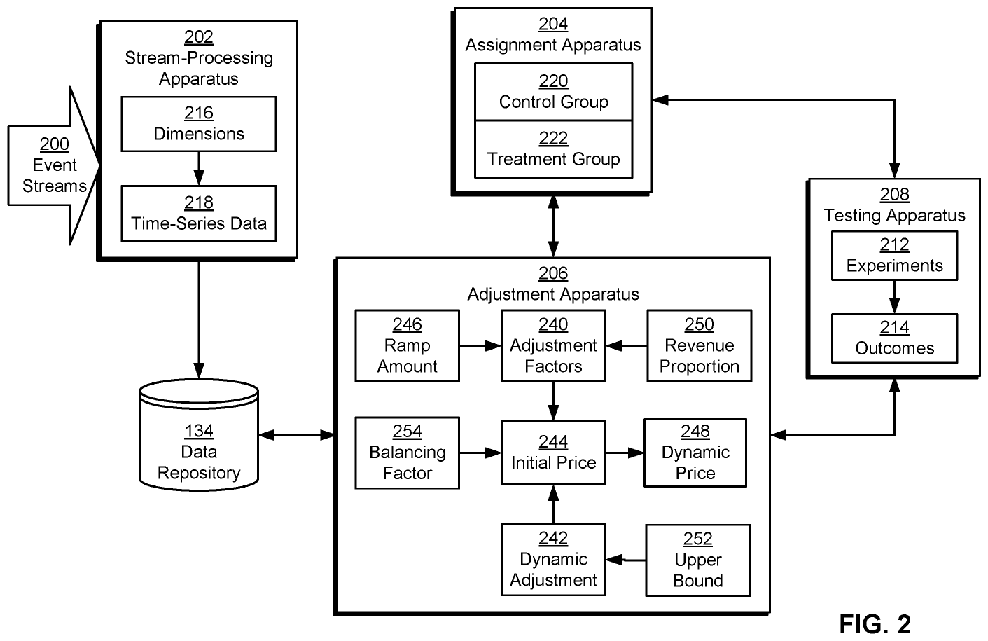

As shown in FIG. 2, a system for performing an experiment strategy includes a stream-processing apparatus 202, an assignment apparatus 204, an adjustment apparatus 206, and a testing apparatus 208. Each of these components is described in further detail below.

Stream-processing apparatus 202 processes event streams 200 containing records of page views, clicks, and/or other activity collected from the monitored systems; performance metrics associated with the activity, such as page load times; and/or other time-series data from the monitored systems. In one or more embodiments, event streams 200 are generated and/or maintained using a distributed streaming platform such as Apache Kafka (Kafka™ is a registered trademark of the Apache Software Foundation). When a profile update, job search, job view, job click, job application, response to a job application, connection invitation, post, like, comment, share, purchase, conversion, member registration, and/or other recent activity occurs within or outside an online system (e.g., online network 118 of FIG. 1), a publisher in the distributed streaming platform generates a record of the activity. The distributed streaming platform may then propagate the record to components subscribing to event streams 200, such as stream-processing apparatus 202.

In one or more embodiments, stream-processing apparatus 202 aggregates records of events from event streams 200 along one or more dimensions 216. In some embodiments, groupings of dimensions 216 by which events in event streams 200 are aggregated represent different “job segments” of jobs posted within the online system. For example, dimensions 216 may include job attributes, such as locations or regions of the jobs (e.g., states within the United States); a standardized language, industry, seniority, education, experience level, skills, and/or title associated with each job; a source of applications for the job (e.g., a jobs module or other onsite source within the online system or a company website or another offsite source that is external to the online system); a payment model for the job (e.g., pay per click (PPC) or a prepaid fixed price throughout the job's lifetime); and/or an availability of a standardized company name for an employer associated with the job. In turn, jobs in each job segment may share a set of common dimensions 216 (e.g., location, industry, seniority, experience level, source of job applications, payment model, availability of standardized company names, etc.).

In one or more embodiments, stream-processing apparatus 202 generates time-series data 218 from aggregated events in event streams 200. For example, stream-processing apparatus 202 may aggregate page views, clicks, applications, CPCs, and/or other types of activity into time-series data 218 based on identifiers for jobs, companies, candidates, and/or other entities in the online system and/or dimensions 216 associated with the jobs, job segments of the jobs, and/or candidates. Such aggregated metrics may include, but are not limited to, a median, a quantile (e.g., 90^{th} percentile), a variance, a mean, a maximum, a minimum, a count (e.g., number of views accumulated over the course of a day), a sum (e.g., a total spending on a job over a day), and/or other summary statistics.

In addition, stream-processing apparatus 202 may aggregate events from event stream 200 in a number of ways. For example, stream-processing apparatus 202 may aggregate sets of a pre-defined consecutive number (e.g., 1000) of events for a given location and key into a single aggregated record. Alternatively, stream-processing apparatus 202 may aggregate records received from event stream 200 along pre-specified intervals (e.g., five-minute intervals) independently of the number of events generated within each interval.

After time-series data 218 is produced, stream-processing apparatus 202 stores time-series data 218 in data repository 134 and/or another data store for subsequent retrieval and use. Stream-processing apparatus 202 may optionally transmit a portion of time-series data 218 directly to assignment apparatus 204, adjustment apparatus 206, testing apparatus 208, and/or another component, in lieu of or in addition to storing time-series data 218 in the data store.

Assignment apparatus 204 divides members of an online system (e.g., online network 118 of FIG. 1) into a control group 220 and a treatment group 220. For example, assignment apparatus 204 may randomly assign a certain ramp amount 246 (e.g., percentage, proportion, etc.) of members to treatment group 222 and the remaining members to control group 220. In another example, assignment apparatus 204 may assign members to treatment group 222 and control group 220 so that both groups have the same distribution of one or more member attributes (e.g., demographic attributes, behavioral attributes, levels of activity, etc.).

Control group 220 includes members that are exposed to a “control” variant of a system for delivering content to the members, and treatment group 222 includes members that are exposed to a treatment variant of the system. For example, members in control group 220 may be exposed to jobs that are charged for delivery over all channels in the online system, and members in treatment group 222 may be exposed to jobs that are charged for delivery over a subset of the channels that optimize for revenue, engagement, and/or performance In treatment group 222, members may continue to be exposed to additional “organic” channels that deliver jobs without performing any optimization related to the jobs, and posters of the jobs may no longer be charged for delivery of the jobs over the organic channels. Alternatively, jobs may be delivered to members in treatment group 222 only through the optimized channels that charge for actions related to the delivered jobs and not through organic channels. By discontinuing charging of jobs that are delivered over non-optimized channels, the system used with treatment group 222 allows posters of the jobs to affect results received from the delivered jobs by adjusting the budgets for the jobs.

A testing apparatus 208 performs a number of experiments 212 using assignments of members to control group 220 and treatment group 222. In one or more embodiments, experiments 212 include controlled experiments 212 (e.g., A/B tests) that control the transition of the online system from charging for content delivered over a larger number of channels to charging for content delivered over a smaller number of channels. During experiments 212, testing apparatus 208 establishes conditions and/or parameters that allow the transition to be conducted in a way that maintains revenue neutrality, engagement neutrality, and/or other desired outcomes 214 between treatment group 222 and control group 220.

For example, testing apparatus 208 may perform each experiment by collecting metrics related to revenue, engagement, and/or performance of jobs delivered to members in control group 220 and treatment group 222. After a given experiment has completed, testing apparatus 208 may determine outcomes 214 that indicate if differences in metrics between control group 220 and treatment group 222 are statistically significant, or conversely, if a lack of difference in metrics between control group 220 and treatment group 222 is statistically significant. When testing apparatus 208 determines that metrics in control group 220 do not significantly differ from those of treatment group 222, testing apparatus 208 may increase ramp amount 246 and repeat the same experiment with a larger proportion of members in treatment group 222.

Adjustment apparatus 206 selects and/or adjusts a number of parameters for controlling the pricing or delivery of content to members in treatment group 222 during experiments 212. For example, adjustment apparatus 206 may select different values and/or combinations of values for the parameters, and testing apparatus 208 may conduct experiments 212 that determine if the resulting delivery of content to treatment group 222 produces metrics and/or outcomes 214 that indicate revenue neutrality, engagement neutrality, and/or other desired results between treatment group 222 and control group 220.

In one or more embodiments, experiments 212 include a first series of experiments 212 that determine one or more adjustment factors 240 to prices for content delivered over a smaller number of channels to treatment group 222 that achieve revenue neutrality and/or engagement neutrality with control group 220. More specifically, adjustment apparatus 206 selects values of adjustment factors 240 for different payment models for content delivered to treatment group 222, and testing apparatus 208 runs experiments 212 that determine if any of the selected values result in revenue neutrality and/or engagement neutrality with control group 220.

For example, adjustment apparatus 206 may select an adjustment factor to achieve revenue neutrality between treatment group 222 and control group 220 using the following equations:

Revenueₜᵣₑₐₜₘₑₙₜ*(1−r)/r=Revenue_{control}

mᵣ=1/OptimizedRevenueProportion*f(r)s.t.

Revenueₜₑₛₜ=ΣBidₜᵣₑₐₜₘₑₙₜ*mᵣ,Revenue_{control}=ΣBid_{control}=ΣBidₜᵣₑₐₜₘₑₙₜ*mᵣ*(1−r)/r=ΣBid_{control}

In the above equations, Revenueₜᵣₑₐₜₘₑₙₜ represents revenue received from treatment group 222, Revenue_{control} represents revenue received from control group 220, and r represents ramp amount 246 (e.g., the proportion of members assigned to treatment group 222 in an experiment). Similarly, Bidₜᵣₑₐₜₘₑₙₜ represents a dynamic price 248 (e.g., a cost per click (CPC)) that is selected for each content item that is delivered to treatment group 222, and Bidₜᵣₑₐₜₘₑₙₜ represents dynamic price 248 that is selected for each content item that is delivered to control group 220. Finally, mᵣ represents the adjustment factor, OptimizedRevenueProportion represents the proportion of revenue that is historically received over optimized channels for delivering the content (e.g., as determined using time-series data 218 from stream-processing apparatus 202 and/or data repository 134), and f(r) represents a value close to 1 that varies with ramp amount 246 and is combined with the inverse of the proportion of revenue that is received over optimized channels to produce the adjustment factor. In other words, the adjustment factor may initially be calculated as the inverse of the historical proportion of revenue received over the optimized channels. The adjustment factor may further be multiplied by f(r) so that the ratio of revenue received from treatment group 222 to revenue received from control group 220 is the same as the ratio of the proportion of members in treatment group 222 to the proportion of members in control group 220.

Continuing with the above example, adjustment apparatus 206 may select another adjustment factor to achieve substantially neutral engagement between control group 220 and treatment group 222 based on the following equations:

PrepaidAppliesₜᵣₑₐₜₘₑₙₜ(m_{ppc},m_{prepaid})−PrepaidApplies_{control}>=−d%

PPCAppliesₜᵣₑₐₜₘₑₙₜ(m_{ppc},m_{prepaid})−PPCApplies_{control}>=−d%

In the above equations, PrepaidAppliesₜᵣₑₐₜₘₑₙₜ represents the rate of job applications in treatment group 222 based on a prepaid payment model for jobs delivered to treatment group 222, and PPCAppliesₜᵣₑₐₜₘₑₙₜ represents the rate of job applications in treatment group 222 based on a PPC payment model for jobs delivered to treatment group 222. Both PrepaidAppliesₜᵣₑₐₜₘₑₙₜ and PrepaidApplies_{control} are affected by m_{ppc} and m_{prepaid}, which represent values of the adjustment factor for PPC jobs and prepaid jobs, respectively. PrepaidApplies_{control} represents the rate of job applications in control group 220 based on a prepaid payment model for jobs delivered to control group 220, and PPCApplies_{control} represents the rate of job applications in control group 220 based on a PPC payment model for jobs delivered to control group 220. As a result, the equations may specify that the drop in member engagement (as measured by job applications) between treatment group 222 and control group 220 is to be no worse than d %.

In one or more embodiments, adjustment apparatus 206 uses the first series of experiments 212 to select values of adjustment factors 240 for PPC and prepaid content (i.e., m_{ppc} and m_{prepaid}) in a way that maintains revenue neutrality and substantially maintains engagement neutrality between treatment group 222 and control group 220, as well as between PPC and prepaid content in treatment group 222. For example, adjustment apparatus 206 may identify a “baseline” proportion of revenue, engagement, and/or other metrics between PPC and prepaid content using historical data from stream-processing apparatus 202 and/or data repository 134. Adjustment apparatus 206 may then calculate one or more adjustment factors 240 that maintain revenue neutrality between treatment group 222 and control group 220 and generate different pairs of adjustment factor values for PPC and prepaid content as variations on the initial value. Testing apparatus 208 may conduct a separate experiment with each pair of values to determine the impact of the pair of values on revenue and/or engagement between treatment group 222 and control group 220. Adjustment apparatus 206 may select one or more pairs of values that result in revenue neutrality and approach engagement neutrality between treatment group 222 and control group 220 and between PPC and prepaid content in treatment group 222. Adjustment apparatus 206 and/or testing apparatus 208 may then increase ramp amount 246 of the corresponding experiment to verify that the revenue and/or engagement neutrality are maintained with increasingly larger proportions of members in treatment group 222.

After adjustment apparatus 206 identifies one or more adjustment factors 240 that achieve revenue and/or engagement neutrality between treatment group 222 and control group 220, adjustment apparatus 206 and testing apparatus 208 use a second series of experiments 212 to update dynamic pricing components that convert an initial price 244 for each content item delivered to treatment group 222 into a given dynamic price 248 that is recalculated every time a ranking of content is generated for delivery over a channel to a member of treatment group 222. Such dynamic pricing components may include, but are not limited to, a dynamic adjustment 242 to initial price 244, an upper bound 252 on dynamic adjustment 242, and/or a balancing factor 254.

For example, adjustment apparatus 206 and/or another component may calculate dynamic price 248 and/or a ranking of content using the following equations:

R_{m,j,t}=pctr_{m,j}*bid_{m,j,t}+μ*pApply_{m,j}

bid_{m,j,t}=bid_{m,j}*f_{j,t}(Sa_{j,t},Sp_{j,t})*f_{m,j}(h_{apply},h_{quality})

In the above equations, R_{m,j,t} represents a ranking score R for member m, job j, and time t; pctr_{m,j} represents the likelihood of the member clicking on the job (e.g., predicted click-through rate); bid_{m,j,t} represents dynamic price 248 for the job with respect to the member and the time; μ represents a balancing factor 254 that balances revenue with engagement in the ranking; and pApply_{m,j} represents the likelihood of the member applying to the job. In turn, dynamic price 248 may be calculated from a value of initial price 244 represented by bid_{m,j}, a first dynamic adjustment 242 to initial price 244 represented by f_{j,t}, and a second dynamic adjustment 242 to initial price 244 represented by f_{m,j}. Content items associated with a member may be ranked by descending score R, and the ranking may be delivered to the member through an “optimized” channel.

As described in the above-referenced application, f_{j,t} may be calculated from Sa_{j,t}, which represents an actual spending for the job at the time, and Sp_{j,t}, which represents the expected spending for the job at that time. In other words, f_{j,t} may be used to “boost” or “throttle” the delivery of the job (e.g., by increasing or decreasing the job's position in the ranking) based on the utilization of the job's budget at time t. Similarly, f_{m,j} may be calculated from h_{apply},which represents a measure of application rates associated with the job, and h_{quality}, which represents a measure of applicant quality associated with the job. Thus, f_{m,j} may include a “performance” score that adjusts the ranking score to control for the quality of applicants and/or the application rate for the job.

Consequently, the equations above can be used to perform multi-objective optimization of content delivery by ranking the content items according to a number of optimization objectives. The optimization objectives include, but are not limited to, a revenue component represented by pctr_{m,j}*bid_{m,j,t} and an engagement component represented by μ*pApply_{m,j}.

In one or more embodiments, adjustment apparatus 206 changes a function for calculating dynamic adjustment 242 so that the function produces a wider range of values for dynamic adjustment 242 than an older version of the function. Continuing with the above example, the older version of the function may include the following:

f_{j,t}(Sa_{j,t},Sp_{j,t})=exp(1−Sa_{j,t}/Sp_{j,t})

And the new version of the function may include the following:

f_{j,t}(Sa_{j,t},Sp_{j,t})=exp [m−(Sp_{j,t}−Sa_{j,t})]

In the new version of the function, m represents a parameter that is selected to control the range of values outputted by the function and/or the amount by which dynamic adjustment 242 is able to react to an imbalance between expected and actual spending.

In one or more embodiments, adjustment apparatus 206 also changes an upper bound 252 for dynamic adjustment 242 to allow dynamic price 248 to reflect the application of adjustment factors 240 to initial price 244. Continuing with the above example, adjustment apparatus 206 may increase upper bound 252 to a value that is selected based on one or more adjustment factors 240 identified in the first series of experiments.

In one or more embodiments, adjustment apparatus 206 updates balancing factor 254 to reflect values of adjustment factors 240 that balance revenue and engagement in the first series of experiments. Continuing with the above example, adjustment apparatus 206 may multiply balancing factor 254 by one or more adjustment factors 240 for prepaid content to obtain an updated balancing factor 254 that is used to generate ranking scores for prepaid content. Similarly, adjustment apparatus 206 may multiply balancing factor 254 by one or more adjustment factors 240 for PPC content to obtain a different updated balancing factor 254 that is used to generate ranking scores for PPC content.

As with the first series of experiments, adjustment apparatus 206 and/or testing apparatus 208 use the second series of experiments 212 to identify and/or select values of dynamic adjustment 242, upper bound 252, balancing factor 254, and/or other dynamic pricing components that result in revenue and/or engagement neutrality between control group 220 and treatment group 222. For example, adjustment apparatus 206 and/or testing apparatus 208 may run experiments 212 with different values of dynamic adjustment 242, upper bound 252, and/or balancing factor 254 until a combination of values results in statistically significant revenue neutrality and/or close to engagement neutrality between control group 220 and treatment group 222. Adjustment apparatus 206 and/or testing apparatus 208 may then increase ramp amount 246 to verify that the revenue and/or engagement neutrality are maintained with increasingly larger proportions of members in treatment group 222.

Finally, assignment apparatus 204, adjustment apparatus 206, and/or testing apparatus 208 conduct one or more experiments 212 that alternate between assigning all members of the online system to treatment group 222 over a period and assigning all members of the online system to control group 220 over a subsequent period. For example, testing apparatus 208 may run an experiment over a two-week period and switch between assigning all members to treatment group 222 and control group 220 on alternating days over the two-week period. During the experiment, testing apparatus 208 may use values of adjustment factors 240, balancing factor 254, dynamic adjustment 242, upper bound 252, and/or other parameters identified in previous experiments 212 to perform pricing and/or delivery of content to treatment group 222. Testing apparatus 208 may aggregate metrics from treatment group 222 and control group 220 over the two-week period, so that each group has a full week's worth of data that can be compared with another full week's worth of data for the other group. In turn, testing apparatus 208 may use the data to verify that the treatment group is substantially revenue and engagement neutral with respect to the control group across the entire marketplace used to deliver content to members of the online system and/or over an entire week's worth of exposure to both treatment group 222 and control group 220.

By discontinuing charging for content delivered over “organic” channels that deliver jobs without performing optimizations related to the jobs and charging only for content delivered over channels that optimize for revenue, engagement, and/or performance, the disclosed embodiments allow the value received by posters of the delivered content to be affected by budgets for the content. At the same time, the use of experiments to update prices and/or parameters for delivering content over different numbers of channels may ensure a stable and/or controlled transition from charging for content delivery over a larger number of channels to charging for content delivery over a smaller number of channels.

In contrast, conventional techniques may continue charging for delivery of content over a predetermined set of channels and/or lack the ability to reduce the number of channels over which paid content is delivered in a controlled fashion. Instead, the conventional techniques may fail to adjust prices and/or other parameters related to pricing for delivered content during changes in the number of channels over which the delivered content is charged, which can lead to loss of revenue, engagement, and/or performance Consequently, the disclosed embodiments may provide improvements in computer systems, applications, user experiences, tools, and/or technologies related to delivering online content and/or carrying out activities within online systems.

Those skilled in the art will appreciate that the system of FIG. 2 may be implemented in a variety of ways. First, stream-processing apparatus 202, assignment apparatus 204, adjustment apparatus 206, testing apparatus 208, and data repository 134 may be provided by a single physical machine, multiple computer systems, one or more virtual machines, a grid, one or more databases, one or more filesystems, and/or a cloud computing system. Stream-processing apparatus 202, assignment apparatus 204, adjustment apparatus 206, and testing apparatus 208 may additionally be implemented together and/or separately by one or more hardware and/or software components and/or layers.

Second, a number of techniques may be used to select and/or identify adjustment factors 240, dynamic adjustment 242, upper bound 252, balancing factor 254, and/or other values related to achieving revenue and/or engagement neutrality between control group 220 and treatment group 222. For example, the functionality of adjustment apparatus 206 and/or testing apparatus 208 may be provided by multi-objective optimization techniques, machine learning models, and/or other computational or technological solutions.

Third, the functionality of the system may be adapted to various types of activities and/or pricing. For example, the system may be used to adjust the pricing and/or delivery of advertisements, posts, images, audio, video, and/or other types of online content based on changes to the amount of delivered content that is charged to posters or providers of the content.

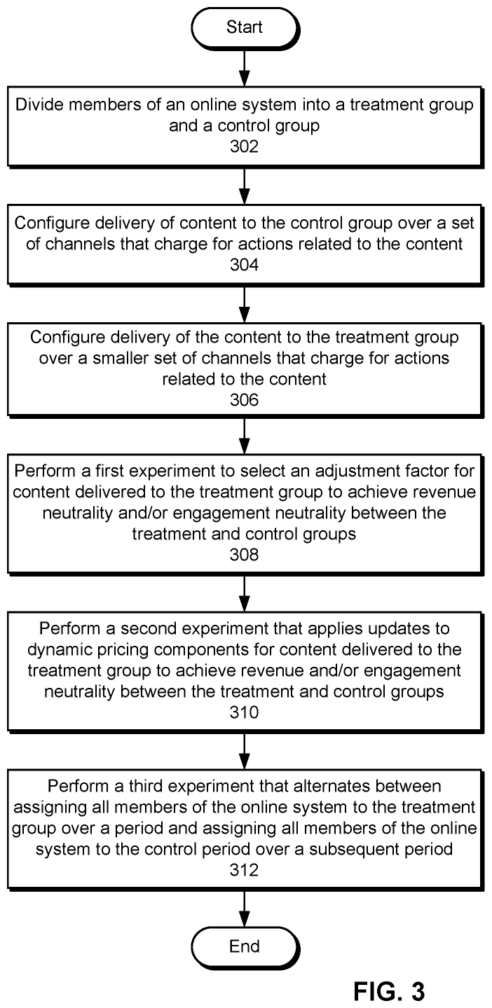

FIG. 3 shows a flowchart illustrating a process of performing an experiment strategy in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, members of an online system are divided into a treatment group and a control group (operation 302). For example, the members may be assigned to the treatment and control groups according to a ramp amount associated with the treatment group.

Next, delivery of content to the control group is configured over a set of channels that charge for actions related to the content (operation 304), and delivery of the content to the treatment group is configured over a smaller set of channels that charge for actions related to the content (operation 306). For example, the larger set of channels over which delivered content to the control group is charged may include both organic channels that do not adjust the prices of the content to optimize for engagement, revenue, and/or performance, as well as optimized channels that do adjust the prices of content to optimize for engagement, revenue, and/or performance. On the other hand, the smaller set of channels over which delivered content to the treatment group is charged may include only the optimized channels.

A first experiment is performed to select an adjustment factor for the content delivered to the treatment group to achieve revenue neutrality and/or engagement neutrality between the treatment and control groups (operation 306). For example, the adjustment factor may initially be set to a value that scales prices of content delivered to the treatment group based on the proportion of members in the treatment group and/or the proportion of revenue that is received over channels used to charge for delivered content in the treatment group. The first experiment may then be used to select an update to the adjustment factor that produces a first level of engagement of the treatment group with the content that is within a margin of a second level of engagement of the control group with the content. The first experiment may additionally select one value of the adjustment factor for a first subset of the content that is delivered based on a prepaid payment model and another value of the adjustment factor for a second subset of the content that is delivered based on a price per action (e.g., PPC) payment model.

A second experiment is subsequently performed that applies updates to dynamic pricing components for content delivered to the treatment group to achieve revenue and/or engagement neutrality between the treatment and control groups (operation 310). For example, the second experiment may update a function for calculating a dynamic adjustment based on an actual spending for a content item at a current time and an expected spending for the content item at the current time, set a higher upper bound for the dynamic adjustment, and/or adjust a balancing factor that balances revenue with engagement in the prices of the content so that dynamic prices for the content can meet the adjustment factor determined in the first experiment.

Finally, a third experiment that alternates between assigning all members of the online system to the treatment group over a period and assigning all members of the online system to the control period over a subsequent period is performed (operation 312). For example, the third experiment may run over a two-week period and alternate between assigning all members to the treatment group and the control group on consecutive days. During the third experiment, metrics collected from the treatment and control groups may be aggregated over the two-week period, so that each group has a full week's worth of data that can be compared with another full week's worth of data for the other group. Consequently, the third experiment may validate revenue and engagement neutrality between the treatment and control groups across the entire marketplace of delivered content in the online system.

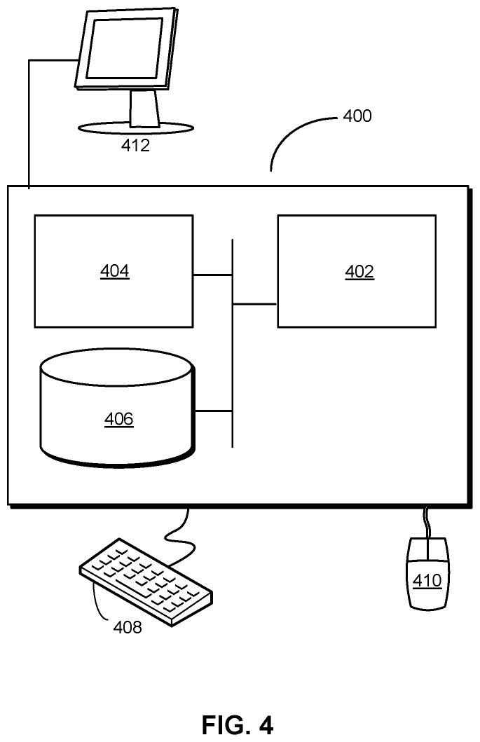

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for performing a member-based ramping experiment strategy. The system includes an assignment apparatus, an adjustment apparatus, and a testing apparatus, one or more of which may alternatively be termed or implemented as a module, mechanism, or other type of system component. The assignment apparatus divides members of an online system into a control group and a treatment group. Next, the assignment apparatus and/or testing apparatus configure delivery of content to the control group over a first set of channels that charge for actions related to the content and delivery of the content to the treatment group over a second set of channels that charge for the actions related to the content, wherein the second set of channels is smaller than the first set of channels. The testing apparatus and adjustment apparatus then perform experiments that select an adjustment factor and/or update dynamic pricing components for content delivered over the second set of channels to the treatment group to achieve revenue neutrality and/or engagement neutrality between the treatment and control groups.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
dividing members of an online system into a control group and a treatment group;
configuring, by one or more computer systems, delivery of content to the control group over a first set of channels that charge for actions related to the content;
configuring, by the one or more computer systems, delivery of the content to the treatment group over a second set of channels that charge for the actions related to the content, wherein the second set of channels is smaller than the first set of channels; and
performing, by the one or more computer systems, a first experiment to select an adjustment factor for content delivered over the second set of channels to the treatment group to achieve revenue neutrality between the treatment and control groups.

2. The method of claim 1, further comprising:
updating the adjustment factor to achieve engagement neutrality between the treatment and control groups.

3. The method of claim 2, wherein updating the adjustment factor to achieve engagement neutrality between the treatment and control groups comprises:
selecting the adjustment factor to produce a first level of engagement of the treatment group with the content that is within a margin of a second level of engagement of the control group with the content.

4. The method of claim 2, wherein updating the adjustment factor to achieve engagement neutrality between the treatment and control groups comprises:
selecting a first value of the adjustment factor for a first subset of the content that is delivered based on a prepaid payment model; and
selecting a second value of the adjustment factor for a second subset of the content that is delivered based on a price per action payment model.

5. The method of claim 1, further comprising:
performing a second experiment that applies updates to dynamic pricing components for the content delivered over the second set of channels to the treatment group to achieve revenue neutrality and engagement neutrality between the treatment and control groups.

6. The method of claim 5, wherein the dynamic pricing components comprise a dynamic adjustment that is calculated based on an actual spending for a content item at a current time and an expected spending for the content item at the current time.

7. The method of claim 6, wherein the updates comprise a higher upper bound for the dynamic adjustment.

8. The method of claim 6, wherein the updates comprise a wider range of values for the dynamic adjustment than an original range of values for the dynamic adjustment.

9. The method of claim 5, wherein the dynamic pricing components comprise a balancing factor for balancing revenue with engagement in rankings of the content.

10. The method of claim 9, wherein the updates comprise scaling of the balancing factor by the adjustment factor.

11. The method of claim 5, further comprising:
performing a third experiment that alternates between assigning all members of the online system to the treatment group over a period and assigning all members of the online system to the control group over a subsequent period.

12. The method of claim 1, wherein the content comprises at least one of:
an advertisement; and
a job.

13. A system, comprising:
one or more processors; and
memory storing instructions that, when executed by the one or more processors, cause the system to:
divide members of an online system into a control group and a treatment group;
configure delivery of content to the control group over a first set of channels that charge for actions related to the content;
configure delivery of the content to the treatment group over a second set of channels that charge for the actions related to the content, wherein the second set of channels is smaller than the first set of channels; and
perform a first experiment that selects an adjustment factor for the content delivered over the second set of channels to the treatment group to achieve revenue neutrality between the treatment and control groups.

14. The system of claim 13, wherein the memory further stores instructions that, when executed by the one or more processors, cause the system to:
update the adjustment factor to achieve engagement neutrality between the treatment and control groups.

15. The system of claim 13, wherein updating the adjustment factor to achieve engagement neutrality between the treatment and control groups comprises:
selecting the adjustment factor to produce a first level of engagement of the treatment group with the content that is within a margin of a second level of engagement of the control group with the content.

16. The system of claim 13, wherein the memory further stores instructions that, when executed by the one or more processors, cause the system to:
perform a second experiment that applies updates to dynamic pricing components for the content delivered over the second set of channels to the treatment group to achieve revenue neutrality and engagement neutrality between the treatment and control groups.

17. The system of claim 16, wherein the dynamic pricing components comprise:
a dynamic adjustment that is calculated based on an actual spending for a content item at a current time and an expected spending for the content item at the current time; and
a balancing factor for balancing revenue with engagement in rankings of the content.

18. The system of claim 17, wherein the updates to the dynamic pricing components comprise:
a higher upper bound for the dynamic adjustment;
a wider range of values for the dynamic adjustment than an original range of values for the dynamic adjustment; and
scaling of the balancing factor by the adjustment factor.

19. The system of claim 13, wherein the memory further stores instructions that, when executed by the one or more processors, cause the system to:
perform a second experiment that alternates between assigning all members of the online system to the treatment group over a period and assigning all members of the online system to the control group over a subsequent period.

20. A non-transitory computer-readable storage medium storing instructions that when executed by a computer cause the computer to perform a method, the method comprising:
dividing members of an online system into a control group and a treatment group;
configuring delivery of content to the control group over a first set of channels that charge for actions related to the content;
configuring delivery of the content to the treatment group over a second set of channels that charge for the actions related to the content, wherein the second set of channels is smaller than the first set of channels; and
performing a first experiment that selects an adjustment factor for the content delivered over the second set of channels to the treatment group to achieve revenue neutrality and engagement neutrality between the treatment and control groups.
